(19) United States
(12) Patent Application Publication
(10) Pub. No.: US 2018/0109101 A1
(43) Pub. Date: Apr. 19, 2018

(54) Ground Fault Detection Architectures, Systems, Circuits, and Methods

(71) Applicant: Ideal Power, Inc., Austin, TX (US)

(72) Inventor: William C. Alexander, Spicewood, TX (US)

(73) Assignee: Ideal Power, Inc., Austin, TX (US)

(21) Appl. No.: 15/582,480

(22) Filed: Apr. 28, 2017

Related U.S. Application Data
(60) Provisional application No. 62/328,955, filed on Apr. 28, 2016.
(60) Provisional application No. 62/329,907, filed on Apr. 29, 2016.

(51) Int. Cl. H02H 1/00; H02H 7/122

(52) U.S. Cl. CPC H02H 1/0007; H02H 7/122

(57) ABSTRACT

A new approach to Ground Fault Detection and Interruption. The entire DC port is driven with a small-amplitude oscillation or modulation, and the power converter's controller tests for the presence of some version of that signal. If the detected oscillations are too small, either as a result of the GFDI fuse being blown, OR as a result of the DC port having too low of an impedance to ground (ground fault), the circuit detects that and causes the power converter to shut down.

### CROSS-REFERENCE

Priority is claimed from U.S. patent applications 62/328,955 and 62/329,907, both of which are hereby incorporated by reference.

### BACKGROUND

The present application relates to Ground Fault Detection and Interruption (“GFDI”), and more particularly to power converters which incorporate GFDI functionality.

Note that the points discussed below may reflect the hindsight gained from the disclosed inventions, and are not necessarily admitted to be prior art.

Ground Fault Detection and Interruption (“GFDI” or “GFCI” or “GFI”) is one of the fundamental safety requirements in residential electric power. If an unwanted current path to ground is created by accident or degradation, the unwanted current can be large enough to cause injury, even if it is not large enough to trip the normal protection breaker. Residential electrical codes in the US increasingly require comprehensive GFDI protection. GFDI protection is often required in locations (e.g. wet locations) where inadvertent ground paths (“fault grounds”) are likely to occur.

GFDI protection is typically required whether or not the end-user's circuit carries a ground voltage to the end device. GFDI protection should activate on excess current to ground, and also when the ground wire itself has faulted through a local ground fault.

For example, in an appliance supplied by a three-wire 240V AC circuit in the US, the neutral terminal will typically be grounded at the transformer. If a local ground fault occurs in the appliance, the current from this ground fault to the remote ground connection can be high enough to blow the fuse on the neutral leg, without blowing the fuse on either of the hot legs. The result is a system in which the “ground” terminal at the appliance is not in fact grounded, so that the system is unprotected. This is very undesirable, so a GFDI configuration should detect this.

### Ground Fault Detection Architectures, Systems, Circuits, and Methods

The present application teaches a new approach to GFDI. This works by causing an entire DC port to oscillate at some frequency or range of frequency, then detecting the resulting oscillations. If the detected oscillations are too small, either as a result of the GFDI fuse being blown, or the DC port having too low of an impedance to ground (ground fault), the circuit detects that and causes the inverter to shut down.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 is a circuit diagram that shows one example of an implementation.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

This application discloses a new approach to GFDI. This works by imposing a small-magnitude AC signal on the entire DC port to oscillate at some frequency or range of frequency, then detecting the resulting oscillations. If the detected oscillations are too small, either as a result of the GFDI fuse being blown, or the DC port having too low of an impedance to ground (ground fault), the circuit detects that and causes the inverter to shut down.

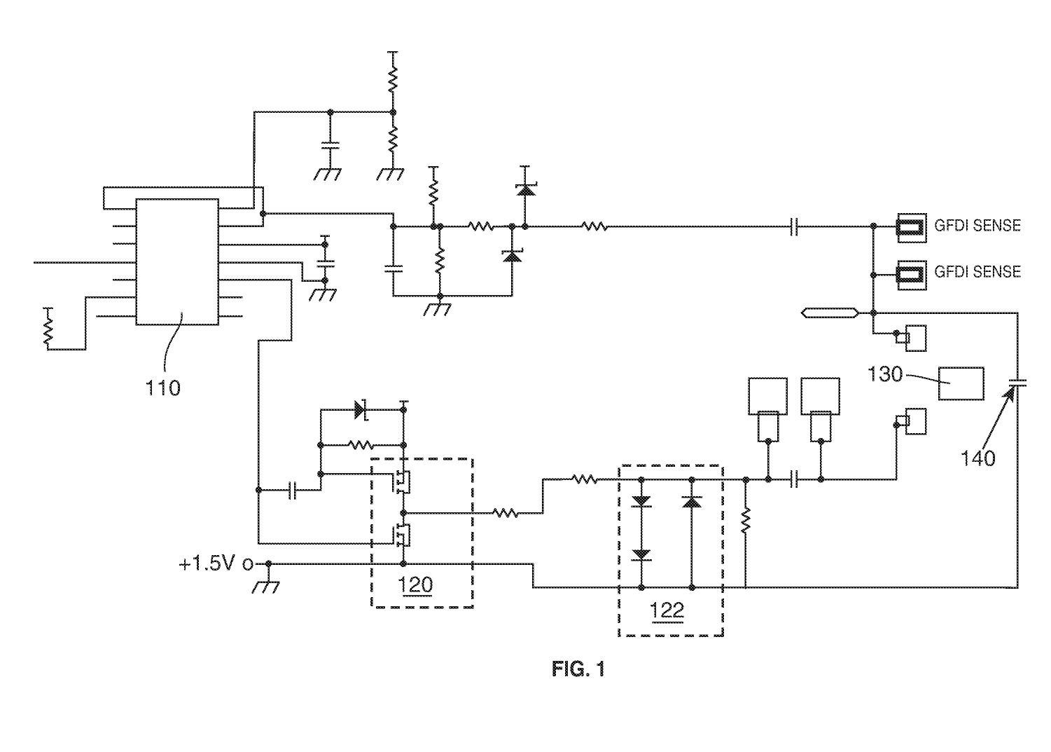

FIG. 1 is a circuit diagram shows one example of an implementation. A controller 110 drives a low-power gain stage 120, which drives an AC signal onto a DC output line. The amplitude of the AC signal is limited, in this example, about +1V/−0.5V by the diode network 122.

Jumpers J9 and J10 permit capacitor C7 to be bypassed, to allow for cases where a ground reference is or is not present.

In this example the gain stage 120 is driven directly by the controller 110, so its output can be simply a square wave. (Alternatively, as discussed below, more complex waveforms can be used if desired.)

In this example the gain stage 120 is driven from a low-voltage supply (only 1.5V), so the signal has a very small amplitude compared to the power transferred through the converter.

A feedback connection GFDI SENSE is AC-coupled to an A/D input of the controller. The controller runs a simple correlation between the oscillator signal and the feedback at its A/D input, to see whether the AC signal from driver stage 120 is getting back to the A/D input.

If the fuse 130 is blown, coupling (through capacitor 140) is much weaker than it would be otherwise. Thus, the noise seen at the A/D input of controller 110 will not correlate with the AC signal from stage 120, and fault handling can be launched.

Similarly, if the DC line has a low impedance to ground (due to a ground fault), the AC signal from driver stage 120 will be absorbed by the low impedance of the ground fault, and the correlation test will produce a small or zero output, and fault handling can be launched. This produces rapid and reliable detection of both kinds of faults.

By contrast, previously proposed systems do not normally detect both kinds of faults.

Additional general background, which helps to show variations and implementations, can be found in the following publications, all of which are hereby incorporated by reference: U.S. Pat. No. 7,599,196, U.S. Pat. No. 7,778,045, U.S. Pat. No. 8,295,069, U.S. Pat. No. 8,391,033, U.S. Pat. No. 8,446,042, U.S. Pat. No. 8,461,718, U.S. Pat. No. 8,531,858, U.S. Pat. No. 9,029,909, U.S. Pat. No. 9,042,131, U.S. Pat. No. 9,077,185, U.S. Pat. No. 9,124,095, U.S. Pat. No. 9,219,406.

Additional general background, which helps to show variations and implementations, as well as some features which can be implemented synergistically with the inventions claimed below, may be found in the following US patent applications. All of these applications have at least some common ownership, copendency, and inventorship with the present application, and all of them, as well as any material directly or indirectly incorporated within them, are hereby incorporated by reference: US 2012-0279567 A1, US 2015-0061569 A1, US 2015-0214055 A1, US 2015-0214299 A1, US 2015-0214782 A1, US 2015-0222194 A1, US 2016-0006254 A1; and all priority applications of any of the above thereof, each and every one of which is hereby incorporated by reference.

### Advantages

The disclosed innovations, in various embodiments, provide one or more of at least the following advantages. However, not all of these advantages result from every one of the innovations disclosed, and this list of advantages does not limit the various claimed inventions.
Better ground-fault protection in power conversion systems.
Detection both of active ground faults and also previously blown ground-fault fusing.

According to some but not necessarily all embodiments, there is provided: A method of operating a power converter, comprising the actions of: a) performing power conversion to transfer power from a first port to a second port; and b) also driving an additional signal, onto at least one wire of the second port, which has a magnitude much smaller than the power transferred in step a), and which contains AC energy; and c) detecting whether the additional signal is propagating through to another wire of the second port.

According to some but not necessarily all embodiments, there is provided: A method of ground fault detection, comprising the actions of: driving an AC signal onto a line which carries a predominantly DC current; and detecting whether the AC signal is propagating along with the DC current, without attenuation due to a blown fuse or a short to ground.

According to some but not necessarily all embodiments, there is provided: A new approach to Ground Fault Detection and Interruption. The entire DC port is driven with a small-amplitude oscillation or modulation, and the power converter's controller tests for the presence of some version of that signal. If the detected oscillations are too small, either as a result of the GFDI fuse being blown, OR as a result of the DC port having too low of an impedance to ground (ground fault), the circuit detects that and causes the power converter to shut down.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In the presently preferred embodiment, as described above, a simple square wave is used as the signal which propagates (or not) to the detection network. However, a variety of alternatives are also contemplated.

For one example, a digital oscillator can be used, so that the output signal is not directly commanded by the controller chip.

For another example, an analog oscillator can be used.

For another example, the signal at the output can be chirped, i.e. have the pulse frequency shifted during the pulse train.

For another example, the signal at the output can be a pseudo-random-noise waveform. Since an autocorrelation operation is preferably run on the transmitted signal, the processing gain permits the amplitude of the transmitted signal to be smaller. (Alternatively, the transmitted signal can be limited to a lower amplitude.)

For another example, a packet characteristic can be superimposed on the pulse train: for example, the waveform might be required to be alternating packets of n and 2n pulses.

It should also be noted that the disclosed inventions can also be adapted to use on AC output lines, with appropriate implementation changes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is, among others (and, without exclusion, in addition to any other points which are indicated herein as inventive and/or surprising and/or advantageous):

1. A method of operating a power converter, comprising the actions of:
a) performing power conversion to transfer power from a first port to a second port; and
b) also driving an additional signal, onto at least one wire of the second port, which has a magnitude much smaller than the power transferred in step a), and which contains AC energy; and
c) detecting whether the additional signal is propagating through to another wire of the second port.

2. The method of claim 1, wherein the second port is a DC port.

3. The method of claim 1, wherein the additional signal is a square wave.

4. The method of claim 1, wherein a single controller circuit operates a driver circuit to perform the driving action, and also performs the detection action itself.

5. A power converter which implements the method of claim 1.

6. A method of ground fault detection, comprising the actions of:
driving an AC signal onto a line which carries a predominantly DC current; and
detecting whether the AC signal is propagating along with the DC current, without attenuation due to a blown fuse or a short to ground.

7. A ground fault detection circuit which implements the method of claim 6.

8. The method of claim 6, wherein the AC signal is a square wave.

9. The method of claim 6, wherein a single controller circuit operates a driver circuit to perform the driving action, and also performs the detection action itself.
